(19) United States
(12) Patent Application Publication
(10) Pub. No.: US 2026/0144403 A1
(43) Pub. Date: May 28, 2026

(54) POT DRAINAGE SYSTEM

(71) Applicants: Aharon Natan Muller, Los Angeles, CA (US); Ariel Yeshayahu Muller, Los Angeles, CA (US)

(72) Inventors: Aharon Natan Muller, Los Angeles, CA (US); Ariel Yeshayahu Muller, Los Angeles, CA (US)

(21) Appl. No.: 18/957,590

(22) Filed: Nov. 22, 2024

(51) Int. Cl. A47J 36/16; A47J 36/20

(52) U.S. Cl. CPC A47J 36/16; A47J 36/20

(57) ABSTRACT

A container with an integrated drainage system. The container may include a pot used to boil pasta or other types of foods. The integrated drainage system may be configured with the pot to enable heated water to be drained from within the pot without having to pour the pasta and/or the heated water over the top rim of the pot (which typically releases dangerous amounts of steam). The drainage system may include a bell crank configured with a piston. The piston may include a lower sealing member that may correspond to an aperture in the bottom of the pot. Movement of the bell crank may cause the piston and its lower sealing member to open the aperture for drainage and/or to close the aperture for use of the pot.

### FIELD OF THE INVENTION

The present invention relates to containers, including a cooking pot with a drainage system.

### BACKGROUND

As is known, pasta is customarily cooked by boiling the pasta in a pot of heated water. Subsequently, when the pasta is ready to be served, the pasta is removed from the pot, e.g., by pouring the contents of the pot into a sieve, or the heated water may be removed from the pot by tilting the pot sideways and pouring the heated water over the pot's top rim.

However, either of these methods may cause a significant amount of steam to be released from the boiling water that may scald the user's hands.

Accordingly, there is a need for a pot with an integrated drainage system.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIGS. 1, 2 and 3 show a container drainage system according to exemplary embodiments hereof;

FIGS. 4 and 4A show aspects of a container drainage system according to exemplary embodiments hereof;

FIGS. 5, 5A and 5B show aspects of a container drainage system according to exemplary embodiments hereof;

FIG. 6 shows aspects of a drainage system according to exemplary embodiments hereof; and

FIGS. 7 and 8 show aspects of a strainer configured with a container drainage system according to exemplary embodiments hereof.

### DETAILED DESCRIPTION OF THE INVENTION

In general, and according to exemplary embodiments hereof, a container and an integrated drainage system is provided. In some embodiments, the container may include a cooking pot, e.g., a pot for boiling pasta, and the integrated drainage system may provide controlled drainage out the lower portion of the pot. In this way, the user is not required to tip the pot sideways to drain hot water out the top of the pot as is customary (thereby avoiding the potential of being burned from the hot steam released from the water as it is poured out the top of the pot).

For the purposes of this specification, the container of the inventive system will be described primarily as a pot for boiling pasta and other types of food products. However, it is understood that the container may comprise any type of container that may benefit from the drainage system and that the scope of the container and of the drainage system is not limited in any way by the type(s) of containers that may be implemented.

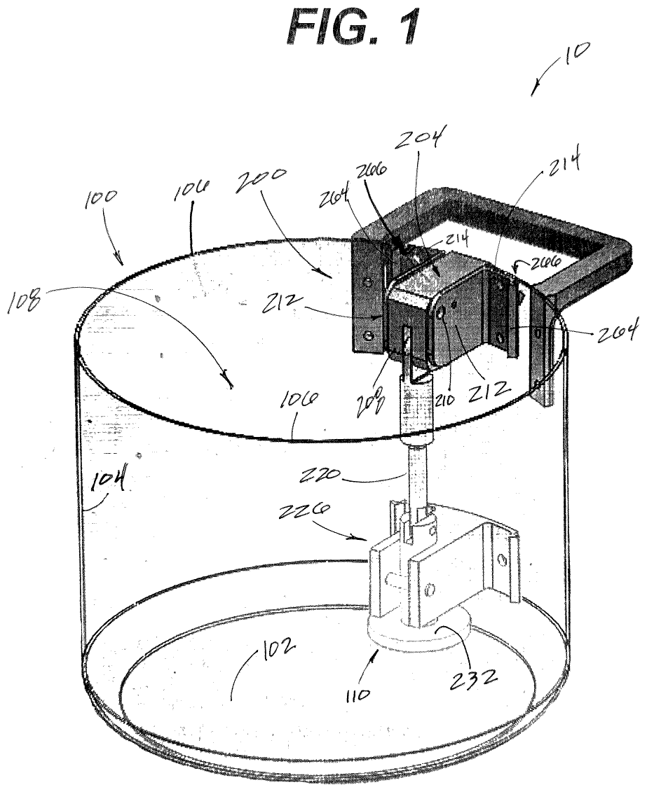

In some embodiments, as shown in FIG. 1, the container drainage system 10 (also referred to herein as simply the system 10) includes a container 100 and a drainage system 200. In general, the drainage system 200 is implemented with the container 100 to provide controlled container drainage functionalities. For example, in some embodiments, the drainage system 200 when implemented provides controlled drainage of the container 100 out the lower portion (e.g., out the bottom of the container 100). The drainage system 200 may be manually and/or automatically activated to provide drainage when desired (e.g., after the pasta has been cooked and it is time to drain the boiling water) and then subsequently deactivated when the drainage has completed. The system 10 also may include other elements and components as necessary to fulfill its functionalities. It also is understood that, in some embodiments, the drainage system 200 may be provided independently from the container 100.

In some embodiments, as shown in FIG. 1, the container 100 includes a bottom side 102 with circumferential sidewalls 104 extending upward to an upper rim 106 (defining an open top) thereby defining a container inner volume 108. The bottom side 102 and/or the sidewalls 104 may include one or more apertures 110 through which fluid from within the container's inner volume 108 may be drained using the drainage system 200. The aperture 110 in FIG. 1 is beneath the sealing member 232 and is thereby obstructed from view in this drawing.

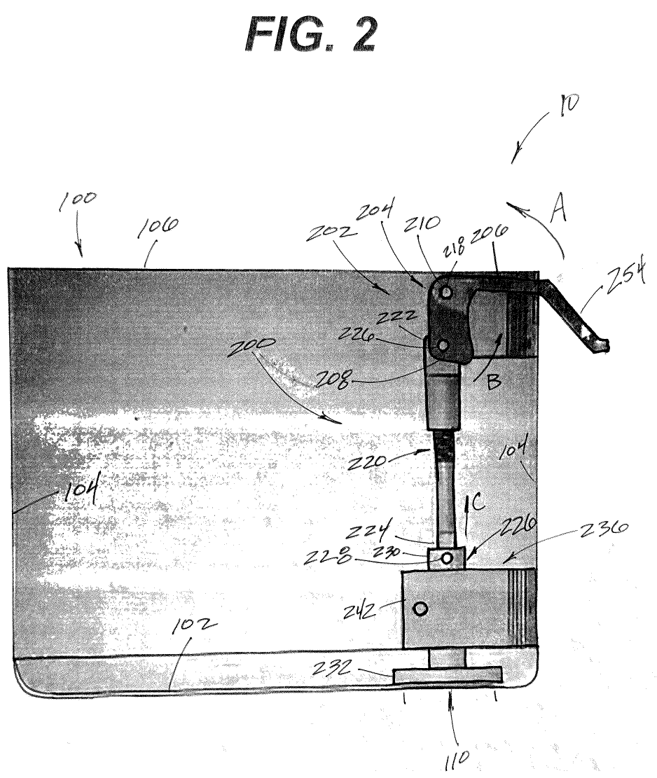

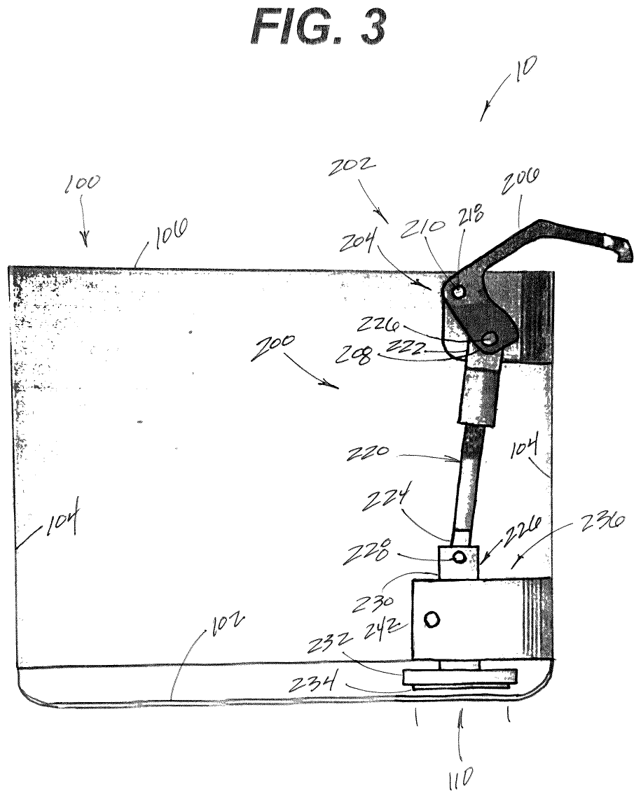

In some embodiments, as shown in FIGS. 1, 2 and 3, the drainage system 200 includes a lever assembly 202 comprising a generally L-shaped bell crank 204 including a first arm 206 and a second arm 208 configured about pivot point 210 (generally at the intersection where the first and second arms 206, 208 meet). In this arrangement, as shown in FIGS. 2 and 3, movement of the first arm 206 in a first direction causes movement of the second arm 208 in a second direction. For example, a general upward counterclockwise movement of the first arm 206 about the pivot point 210 in the direction of the arrow A in FIG. 2 may cause the second arm 208 to move generally upward and laterally to the right (also in a counterclockwise direction) in the direction of the arrow B. This may result in the arrangement as shown in FIG. 3.

Conversely, downward movement of the first arm 206 in FIG. 3 in a generally clockwise direction (e.g., in a direction generally opposite the direction of the arrow A) may cause the second arm 208 to move generally downward and to the left (also in a clockwise direction). As described in other sections, the upward movement of the first arm 206 (arrow A) may cause the drainage system 200 to open (FIG. 3) and a downward movement of the first arm 206 (opposite arrow A) may cause the drainage system 200 to close (FIG. 2).

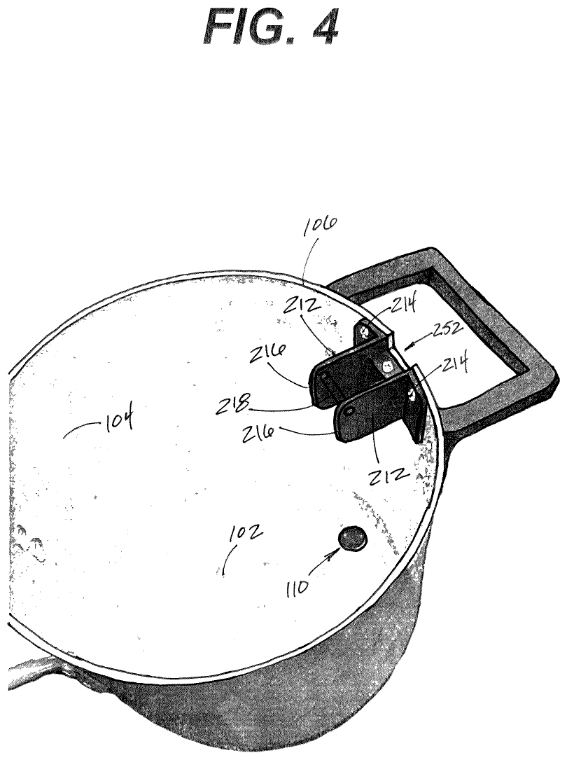

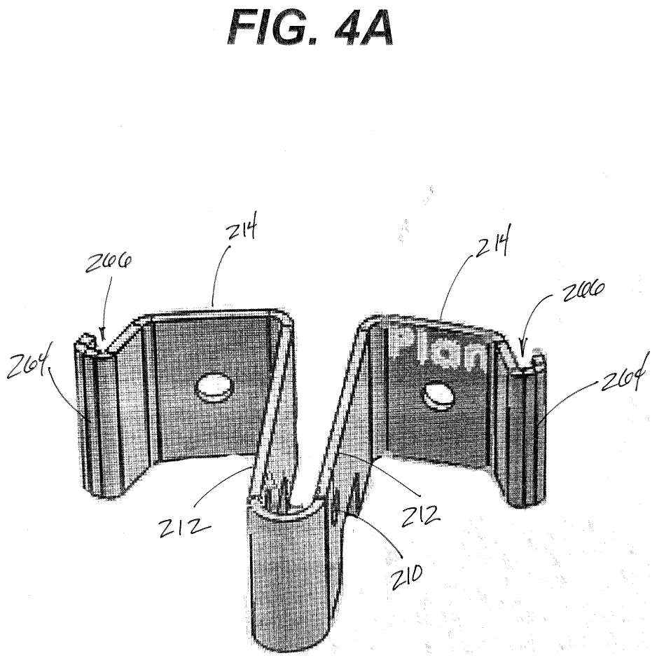

In some embodiments, as shown in FIGS. 1 and 4, the bell crank 204 may be supported and coupled to the inner sidewalls 104 of the container 100 by one or more support arms 212. FIG. 4 shows the bell crank 204 removed from the support arms 212 for clarity. In some embodiments, as shown in FIG. 4, the lever assembly 202 may include a first support arm 212 configured on the left side of the bell crank 204 and including an attachment portion 214 coupled to the container's inner sidewall 104 and a support portion 216 extending into the container's inner volume 108 (e.g., generally perpendicular to the sidewalls 104). The lever assembly 202 also may include a second support arm 212 configured on the right side of the bell crank 204 and including an attachment portion 214 coupled to the container's inner sidewall 104 and a support portion 216 extending into the container's inner volume 108 (e.g., generally perpendicular to the sidewalls 104). A first pivot mechanism 218, e.g., a pin or dowel, may extend between the second portions 216 of the first and second support arms 212 (e.g., through holes in the second portion distal ends) and through the bell crank 204 at its pivot point 210 (e.g., through a hole through the bell crank 204 at this location as shown in FIGS. 1-3). In this way, the pivot mechanism 218 (e.g., the pin) may be held stable for the bell crank 204 to rotate about. The first portions 214 of the support arms 212 may be coupled to the container's inner sidewalls using rivets, bolts and nuts, screws, welding, and/or using other suitable attachment mechanisms.

FIG. 4A shows another embodiment wherein the first and second support arms 212 are formed from a single plate and are thereby connected in the front by a bent portion.

In some embodiments, as shown in FIGS. 1, 2 and 3, the lever assembly 202 includes a piston 220 including a first end 222 (e.g., an upper end) and a second end 224 (e.g., a lower end). The piston's first end 222 may be rotatably coupled to a distal end of the bell crank's second arm 208 using a second pivot mechanism 226 (e.g., a pin or dowel passing through a hole in the piston's first end 222 and through a hole in the bell crank's second arm 208). In this way, when the second arm 208 of the bell crank 204 is moved due to the rotation of the bell crank 204, the piston's first end 222 (and therefore the overall piston 220 itself) also may be caused to move in a similar direction.

In some embodiments, the piston's second end 224 (e.g., its lower end) may be rotatably coupled to an upper neck portion 230 of a sealing assembly 226 using a third pivot mechanism 228 (e.g., a pin or dowel passing through a hole in the piston's second end 224 and through a hole in the sealing assembly 226). In this way, when the piston 220 is caused to move upward and/or downward due to the rotation of the bell crank 204, the sealing assembly 226 also may be caused to move in a similar direction.

For example, when the bell crank's first arm 206 is caused to move upward in the direction of the arrow A thereby causing the bell crank's second arm 208 to move upward in the direction of the arrow B, the sealing assembly 226 may be caused to move upward in the direction of the arrow C (see FIG. 2). As described in other sections, this may cause the drainage system 200 to open. Conversely, when the bell crank's first arm 206 is caused to move downward in the direction generally opposite of the arrow A thereby causing the bell crank's second arm 208 to move downward in the direction generally opposite of the arrow B, the sealing assembly 226 may be caused to move downward in the direction generally opposite of the arrow C (see FIG. 2). As described in other sections, this may cause the drainage system 200 to close.

In some embodiments, the bell crank 204 may be spring-loaded such that the bell crank 204 may be biased towards its downward closed position when moved into this position and/or biased towards its upper open position when moved into this position. As such, the bell crank 204 may generally snap into place in its lower position and/or in its upper position and be held thereat until intentionally moved.

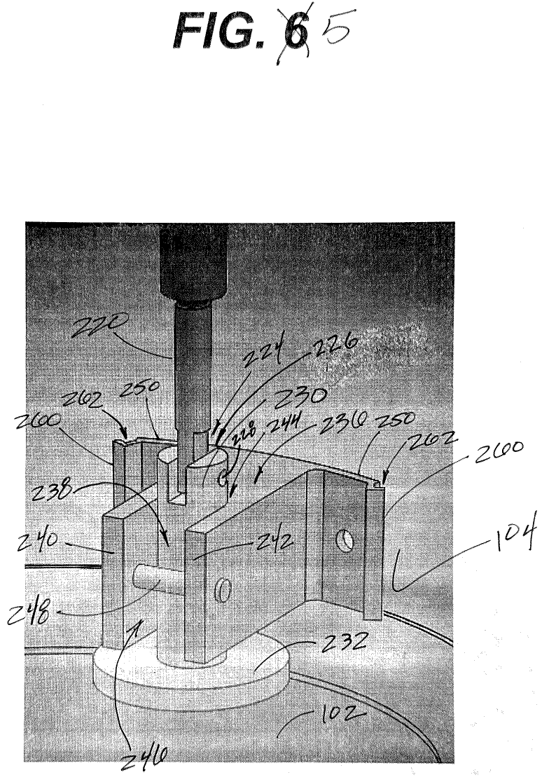

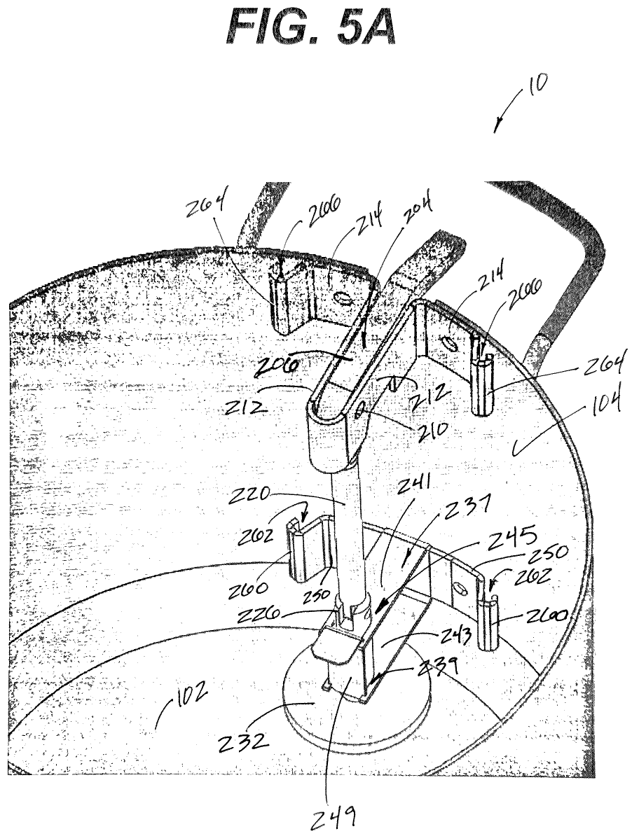

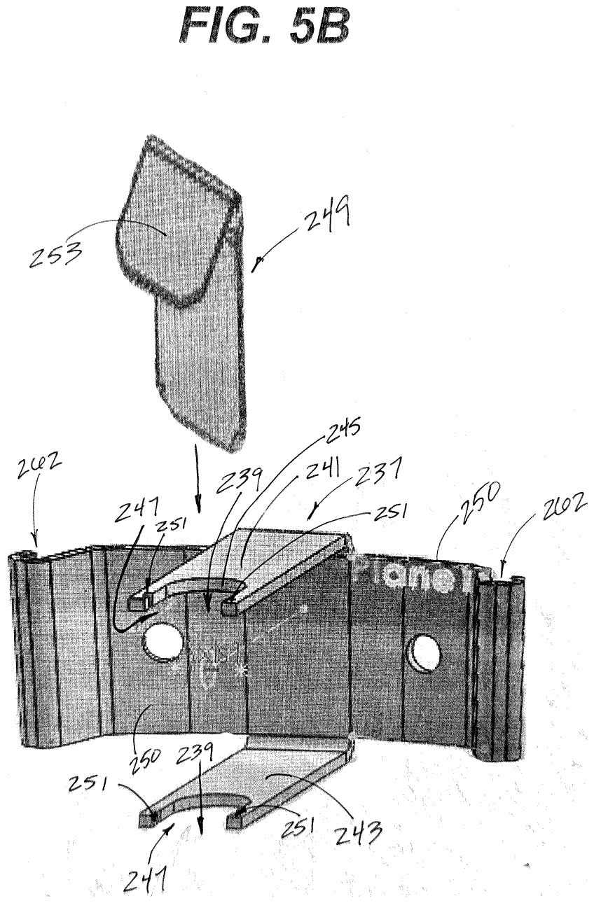

FIG. 5 shows a close-up view of the sealing assembly 226 coupled to the lower end 224 of the piston 220.

In some embodiments, as shown in FIG. 5, the sealing assembly 226 includes a neck portion 230 with a lower end coupled to a sealing member 232. The sealing member 232 may be designed to generally correspond to the container's aperture 110 in its bottom side 102 so that when the sealing member 232 is caused to move downward with the downward movement of the sealing assembly 226, the sealing member 232 may engage with the container's bottom side 102 in the area around the aperture 110 to seal the aperture 110 closed. That is, the sealing member 232 may generally cover the aperture 110 and seal it fluid tight. In some embodiments, the sealing member 232 may include a gasket 234 or O-ring on its lower side (see FIG. 3) that may engage the container's bottom side 102 and/or the circumferential rim of the aperture 110 to ensure a fluid tight fit. The gasket 234 may preferably comprise a high temperature resistant material so that it may withstand the high temperatures that the system 10 may encounter during use (e.g., the heat of a stovetop burner and/or of the boiling of water within the container 100).

In some embodiments, as shown in FIG. 5, the sealing assembly 226 is supported by a support member 236 comprising a support channel 238 formed between a left support arm 240 and a right support arm 242. The support channel 238 also includes a back side wall 244 and an open front side 246. The support channel 238 also may include a width between the left and right support arms 240, 242 that generally matches the diameter of the sealing assembly's neck portion 230. In this way, the neck portion 230 may be held generally upright and free to move up and down within the channel 238 with little to no room for lateral movement side-to-side.

In addition, in some embodiments, the support channel 238 may include a front gate member 248 (e.g., a pin or dowel passing through corresponding and holes in the left and right support arms 240, 242, and/or a suitable latch, etc.) that may, when implemented, block the neck portion 230 from passing through the open front side 246 of the channel 238. It may be preferable that the neck portion 230 be held between the gate member 248 and the channel's back side wall 244 while being free to move up and down but with little to no lateral movement front-to-back. In this way, the neck portion 230 may be held upright and stable left-to-right (by the left and right support arms 240, 242) and front-to-back (e.g., by the front gate member 248 and the back wall 244 of the channel 238).

In some embodiments, the gate member 248 may be displaceable, e.g., removable, able to be pushed to the side, etc., thereby enabling the sealing assembly's neck portion 230 to be removed from the support channel 238 through the channels open front side 246. This may allow the piston 220 and the sealing assembly 226 to be released to be more easily cleaned. Subsequently, the piston 220 and the sealing assembly 226 may be reconfigured within the support channel 238 and the gate member 248 may be returned to its implemented and locked position for use of the system 10.

In some embodiments, the support member 236 may include left and right attachment portions 250 that may be attached to the container's inner sidewalls 104 (e.g., using rivets, bolts and nuts, screws, welding, and/or using other attachment mechanisms) to couple the support member 236 to the container 100. In some embodiments, the left and right attachment mechanisms 250 may extend outward (e.g., to the left and right, respectively) generally perpendicularly from the rear portions of the left and right support arms 240, 242.

In another embodiment, as shown in FIGS. 5A and 5B, the sealing assembly 226 is supported by a support member 237 comprising a support channel 239 formed as a distal cutout in an upper support arm 241 and in a corresponding lower support arm 243. The support channel 239 also includes a back side wall 245 and an open front side 247. The support channel 239 also may include a width that generally matches the diameter of the sealing assembly's neck portion 230. In this way, the neck portion 230 may be held generally upright and free to move up and down within the channel 238 with little to no room for lateral movement side-to-side (see FIG. 5A). In some embodiments, the support member 237 may include left and right attachment portions 250 as described in other sections.

In addition, in some embodiments, the support channel 239 may include a front gate member 249, e.g., comprising a plate that may be received into distal upper and lower left and right side notches 251 in the cutout that forms the support channel 239. The gate member 249 may be inserted into the side notches 251, e.g., from above as shown in FIG. 5B to secure the neck portion 230 and to prevent it from passing through the open front side 247 of the channel 239. It may be preferable that the neck portion 230 be held between the gate member 249 and the channel's back side wall 245 while being free to move up and down but with little to no lateral movement front-to-back. In this way, the neck portion 230 may be held upright and stable left-to-right (e.g., within the cutout channel 239) and front-to-back (e.g., by the front gate member 249 and the back wall 245 of the channel 239).

In some embodiments, the gate member 249 may be displaceable, e.g., removable. For example, as shown in FIG. 5B, the gate member 249 may be lifted upward and removed from the notches 251, thereby enabling the sealing assembly's neck portion 230 to be removed from the support channel 239 through the channels open front side 247. This may allow the piston 220 and the sealing assembly 226 to be released to be more easily cleaned. Subsequently, the piston 220 and the sealing assembly 226 may be reconfigured within the support channel 239 and the gate member 249 may be returned to its implemented and locked position for use of the system 10. In some embodiments, the gate member 249 may include a gripping tab 253, e.g., extending from its upper end forward, that the user may grasp to manipulate the member 249.

In some embodiments, as shown in FIGS. 2 and 3, when the piston 220 is caused to move from a lower position (FIG. 2) to an upper position (FIG. 3), the orientation of the piston 220 with respect to a vertical axis may shift. For example, as shown in FIG. 3, when the bell crank 210 is activated to cause its second arm 226 to move upward and to the right (arrow B in FIG. 2), the piston 220 rotatably coupled to the second arm 226 may be caused to tilt in a similar direction (i.e., to the right in FIG. 3). However, because the lower end 224 of the piston 220 may be rotatably configured with the upper neck 230 of the sealing assembly 226, and the upper neck 230 may be generally prevented from lateral movement, the piston 220, when caused to tilt, may simply rotate about the third pivot mechanism 228 at the interface between the piston 220 and the neck 230. As such, the piston 220 may be caused to tilt but the sealing assembly's neck portion 230 (and the sealing member 232 coupled beneath it) may be held generally upright and vertical. This may enable the sealing member 232 to be lifted and lowered in a generally vertical motion thereby ensuring consistent and repeatable motion and a reliable fluid tight seal with the container's bottom aperture 110 when closed.

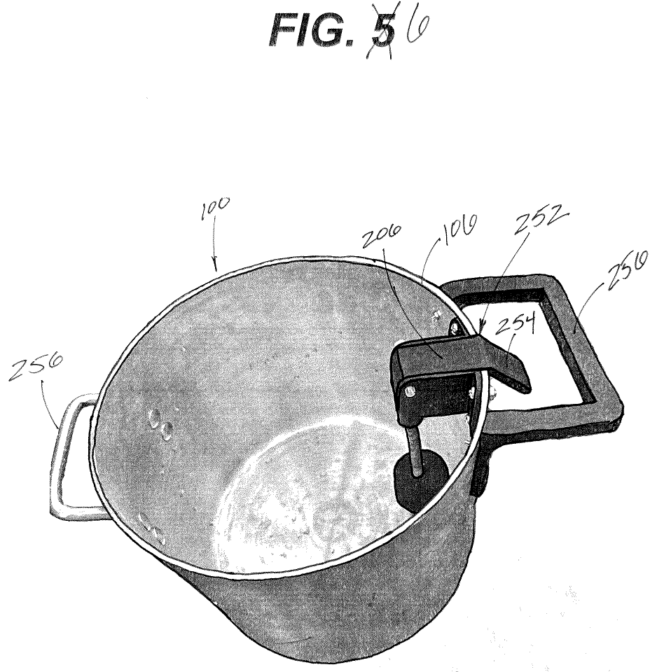

In some embodiments, as shown in FIG. 4, the container's rim 106 may include an upper facing notch 252 in an area between the bell crank's left and right support arms 212. The notch 252 may be sized to receive the thickness of the bell crank's first arm 206 such that the top surface of the first arm 206, when the first arm 206 is in its lower position as shown in FIG. 2, may be generally even with or slightly below the container's rim 106. The result of this is shown in FIGS. 6 and 2. This may allow a lid to be placed on the rim 106 of the container 100 without obstruction for use during cooking procedures.

In some embodiments, as shown in FIGS. 2, 3 and 6, the bell crank's first arm 206 may include an extension portion 254 that may be coupled to and that may extend away from the distal end of the first arm 206. In some embodiments, the extension portion 254 may extend at an offset angle with respect to the first arm 206, e.g., at a generally downward angle. The extension portion 254 may provide a portion of the bell crank 204 that a user may easily grip and manipulate up and/or down to open and/or close the drainage system 200.

In some embodiments, as shown in FIG. 6, the container 100 may include one or more handles 256 to enable a user to hold the container 100 during use. In some embodiments, the container 100 may include a first handle 256 that is coupled to the container and that extends from a position to the left of the lever assembly 202 to a position to the right of the lever assembly 202. It may be preferable that the first handle 256 extend a distance away from the container to allow room for the bell crank's first arm 206 and its extension portion 254 to be gripped and manipulated without obstruction. In some embodiments, the container 100 also may include a second handle 256 on a side and position generally opposite the first handle 256.

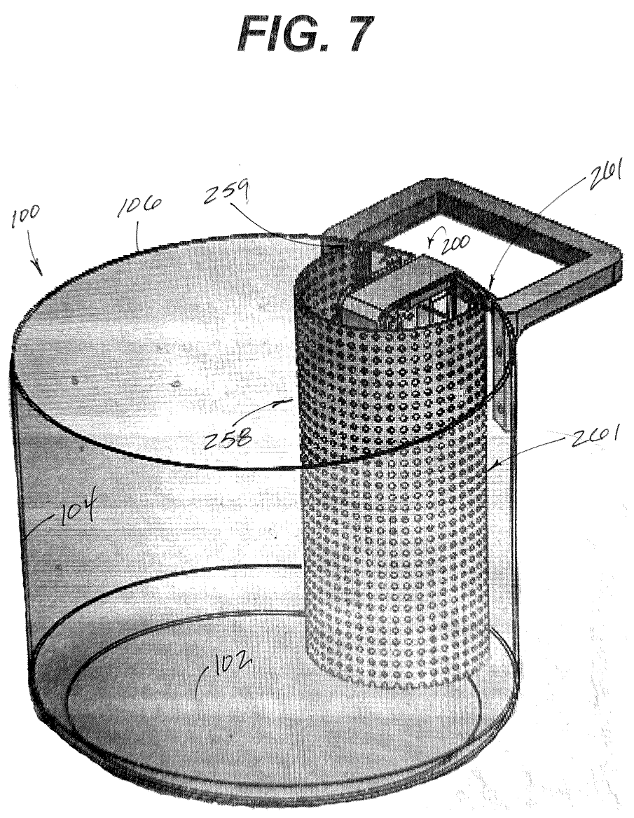

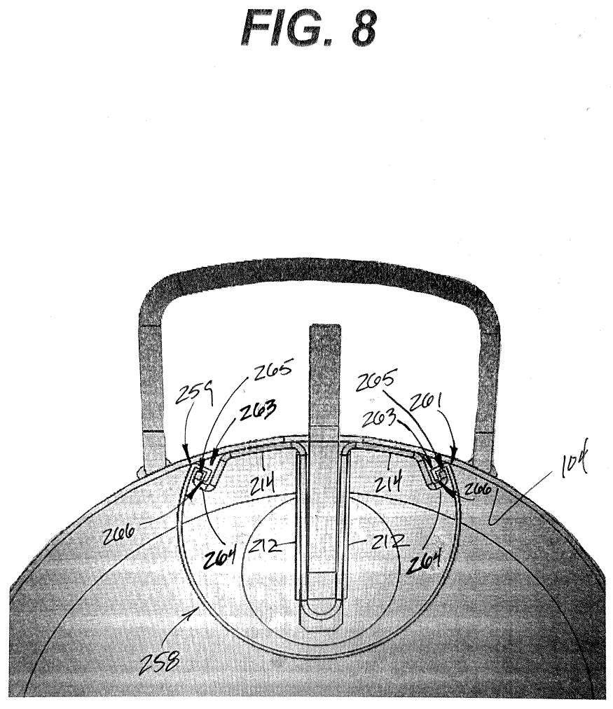

FIG. 7 shows a perspective view of the system 10 with a strainer 258, and FIG. 8 shows a top view of the same.

In some embodiments, as shown in FIGS. 7 and 8, the system 10 may include a strainer 258 that may be configured to generally shield the drainage system 200 from pasta and/or other items (e.g., other types of food) that may be located in the container's inner volume 108, e.g., during a cooking procedure. This may prevent such pasta from obstructing, jamming or otherwise interfering with the functionalities of the drainage system 200. In some embodiments, the strainer 258 may include a porous sheet of material (e.g., a metal or plastic mesh) formed to semi-encircle the drainage system 200 within the container's inner volume 108.

In some embodiments, the strainer 258 may extend from a first position (e.g., to the left of the drainage system 200) to a second position (e.g., to the right of the drainage system 200). For example, a first side edge 259 of the strainer 258 may be removably coupled to the container's sidewall 104 at the first position and a second side edge 261 of the strainer 258 generally opposite the first side edge 259 may be removably coupled to the container's sidewall 104 at the second position.

In some embodiments, as shown in FIGS. 5 and 5A, the sealing assembly's support member's left and right attachment portions 250 may each include an attachment clip 260 at a distal edge extending from the top of the attachment portion 250 to the bottom of the attachment portion 250. Each attachment clip 260 may form a vertical attachment notch 262. Similarly, as shown in FIG. 8, the lever assembly's first and second support arm's attachment portions 214 may each include an attachment clip 264 at a distal edge extending from a top of the attachment portion 214 to the bottom of the attachment portion 214. These attachment clips 264 may each form a vertical attachment notch 266. In some embodiments, the system's left side upper and lower attachment clips 264, 260 and corresponding attachment notches 266, 262 may be aligned vertically, and the system's right side upper and lower attachment clips 264, 260 and corresponding attachment notches 266, 262 also may be aligned vertically.

In some embodiments, as shown in FIGS. 7 and 8, the strainer's first side edge 259 may be received into the system's left side attachment notches 266, 262 and the strainer's second side edge 261 may be received into the system's right side attachment notches 266, 262 to hold the strainer 258 removably secured about the drainage system 200. In this way, the strainer 258 may be removably secured to the system 10.

In some embodiments, the strainer's first and second side edges 259, 261 may each include attachment clips 263 (formed by a crimp or similar in the edges 259, 261 (at the top of the strainer 258 and at the bottom of the strainer 258, and preferably extending therebetween) that may each form respective attachment notches 265. In some embodiments, these attachment clips 263 and corresponding notches 266 on the strainer 258 may be received into the system's left and right side upper and lower attachment clips 264, 260 and corresponding attachment notches 266, 262 to removably secure the strainer 258 with the system 10.

In use, the strainer 258 (e.g., the strainer's left and right attachment clips 263 and corresponding attachment notches 265) may be inserted into the corresponding left and right side attachment notches 266, 262 from above and slid downward until the bottom end of the strainer 258 rests against the bottom 102 of the container 100 (preferably flush against the bottom 102). In some embodiments, the strainer 258 may be removably held in this lower position by detents and/or other releasable attachment mechanisms, e.g., configured with the strainer's first and second edges 259, 261 (and/or in the attachment clips 263 and/or attachment notches 265) and the corresponding left and/or right attachment clips 264, 260 and corresponding attachment notches 266, 262. In this way, the strainer 258 may be installed and held securely in place until intentionally removed. In some embodiments, the top of the strainer 258 when configured with the drainage system 200 is preferably flush with or slightly below the top rim 106 of the container 100 such that a lid may be placed onto the container's open top side when desired without obstruction.

It is understood that any details and/or aspects of any embodiments of the pull tab system 10 described herein may be combined with any details and/or aspects of any other embodiments of the pull tab system 10 in any way to form additional embodiment(s) of the pull tab system 10 all of which are within the scope of the pull tab system 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs” and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A drainage system for use with a container, the drainage system comprising:
a lever configured to rotate about a first pivot point;
a piston including a first end rotatably configured with the lever and a second end rotatably configured with a sealing member;
wherein movement of the lever in a first direction about the first pivot point causes the sealing member to close an aperture in the container, and movement of the lever in a second direction about the first pivot point causes the sealing member to open the aperture in the container.

2. The drainage system of claim 1 further comprising a support channel configured to hold the sealing member substantially vertical.

3. The drainage system of claim 2 wherein when the lever is moved in the first direction, the piston is tilted, and the support channel holds the sealing member substantially vertical.

4. The drainage system of claim 3 wherein the second end of the piston and the sealing member are rotatably configured about a common second pivot point.

5. The drainage system of claim 4 wherein when the piston is tilted, the second end of the piston rotates with respect to the sealing member about the second pivot point.

6. The drainage system of claim 2 wherein the support channel includes a displaceable gate at a front end of the support channel.

7. The drainage system of claim 2 wherein the support channel is formed between opposing first and second channel support arms.

8. The drainage system of claim 7 wherein the first and second channel support arms each include a first attachment notch adapted to receive an edge of a strainer.

9. The drainage system of claim 1 wherein the first pivot point is formed in a lever support arm.

10. The drainage system of claim 9 wherein the lever support arm includes a second attachment notch adapted to receive an edge of a strainer.

11. The drainage system of claim 1 wherein the lever includes a bell crank.

12. A container drainage system comprising:
a container including a bottom and sidewalls defining a container inner volume, and an aperture in the bottom;
a bell crank supported about a first pivot point coupled to the container;
a piston including a first end rotatably configured with the lever and a second end rotatably configured with a sealing member;
wherein movement of the lever in a first direction about the first pivot point causes the sealing member to close the aperture in the container, and movement of the lever in a second direction about the first pivot point causes the sealing member to open the aperture in the container.

13. The container drainage system of claim 12 further comprising a support channel configured to hold the sealing member, wherein when the lever is moved in the first direction, the piston is tilted, and the support channel holds the sealing member substantially vertical.

14. The container drainage system of claim 13 wherein the second end of the piston and the sealing member are rotatably configured about a common second pivot point, and wherein when the piston is tilted, the second end of the piston rotates with respect to the sealing member about the second pivot point.

15. The container drainage system of claim 13 wherein the support channel includes a displaceable gate at a front end of the support channel.

16. The container drainage system of claim 13 wherein the support channel is formed between opposing first and second channel support arms.

17. The container drainage system of claim 16 wherein the first and second channel support arms each include a first attachment notch adapted to receive an edge of a strainer.

18. The container drainage system of claim 12 wherein the first pivot point is formed in a lever support arm.

19. The container drainage system of claim 18 wherein the lever support arm includes a second attachment notch adapted to receive an edge of a strainer.

20. The container drainage system of claim 13 wherein the lever includes a bell crank.
